(19) United States
(12) Patent Application Publication
(10) Pub. No.: US 2005/0066178 A1
(43) Pub. Date: Mar. 24, 2005

(54) Method and apparatus for controlling access to memory

(76) Inventors: Vernon E. Rowe, Fort Worth, TX (US); Mark Ford, Sanger, TX (US); F. Javier Hernandez, Houston, TX (US); Eric Lawson, Dallas, TX (US)

Correspondence Address: Garlick & Harrison, P.O. Box 160727, Austin, TX, 78716-0727, US

(21) Appl. No.: 09/919,359

(22) Filed: Jul. 31, 2001

Related U.S. Application Data
(60) Provisional application No. 60/221,715, filed on Jul. 31, 2000.

(51) Int. Cl. H04K 1/00

(52) U.S. Cl. 713/182

(57) ABSTRACT

The present invention discloses an apparatus and a method for forming a protective layer around computer memory that allows access to specified external locations and applications only. A routine seeking access to the computer memory must be cleared for access by at least two different permission checking algorithms that work in conjunction to a database to determine whether access should be allowed. The invention protects the hard drive from unauthorized reading and writing by verifying permission definitions from a hard drive database and monitors startup files for changes from previous versions to prevent unauthorized control of the computer recourses at the outset of its operation upon power up. Additionally, the present invention will protect from unauthorized TCP/IP connections by verifying permissions from a TCP/IP permissions database.

### CROSS REFERENCE TO RELATED APPLICATION

The following application claims priority to Provisional Application for Patent entitled METHOD AND APPARATUS FOR CONTROLLING ACCESS TO MEMORY, said application having a filing date of Jul. 31, 2000 and a serial number of 60/221,715.

### BACKGROUND

1. Technical Field

The present invention relates generally to computer systems, and more particularly, to hardware and software for protecting memory contents and preventing access to system components.

2. Related Art

Firewall technology includes hardware and software that merely examines an external sources seeking access to the logical or physical ports of a computer to determine if the external source seeking access is one that is not authorized to gain access. Additionally, common firewall technology typically minimizes the number logical and physical ports that are operationally allowed to receive and respond to access requests and probes. Because the standard firewall technology requires the computer to be an electronic recluse, it is not allowed to operate as freely as it might with a known good external location. Additionally, because firewall technologies work on an exclusionary basis, lists of excluded sources and programs must be continuously updated. For example, current viruses including the Melissa Virus and the I Love You Virus ravaged many systems until filtering programs were updated to detect these known viruses. Accordingly, most firewall systems were ineffective in protecting the unauthorized access by these viruses. SUMMARY OF THE INVENTION

To overcome the shortcomings of the prior systems and their operations, the present invention contemplates an apparatus and a method for forming a protective layer around computer memory that allows access to specified external locations and applications only. Stated differently, every source that seeks access to read or write to a computer's memory must be listed in memory prior to access being given. Additionally, the present invention monitors its startup files for changes from previous versions to prevent unauthorized control of the computer resources at the outset of its operation upon power up.

Other aspects of the present invention will become apparent with further reference to the drawings and specification that follow.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a system according to one aspect of the present invention.

FIGS. 2A and 2B are block diagrams illustrating the functional allocations of the present invention in terms of a process flow.

FIG. 3 is a functional block diagram of a computer system formed according to the present invention.

FIG. 4 is a flow chart illustrating a process for protecting computer memory according to one embodiment of the present invention.

FIG. 5 illustrates the system design in terms of software and operational layers.

### DETAILED DESCRIPTION OF THE DRAWINGS

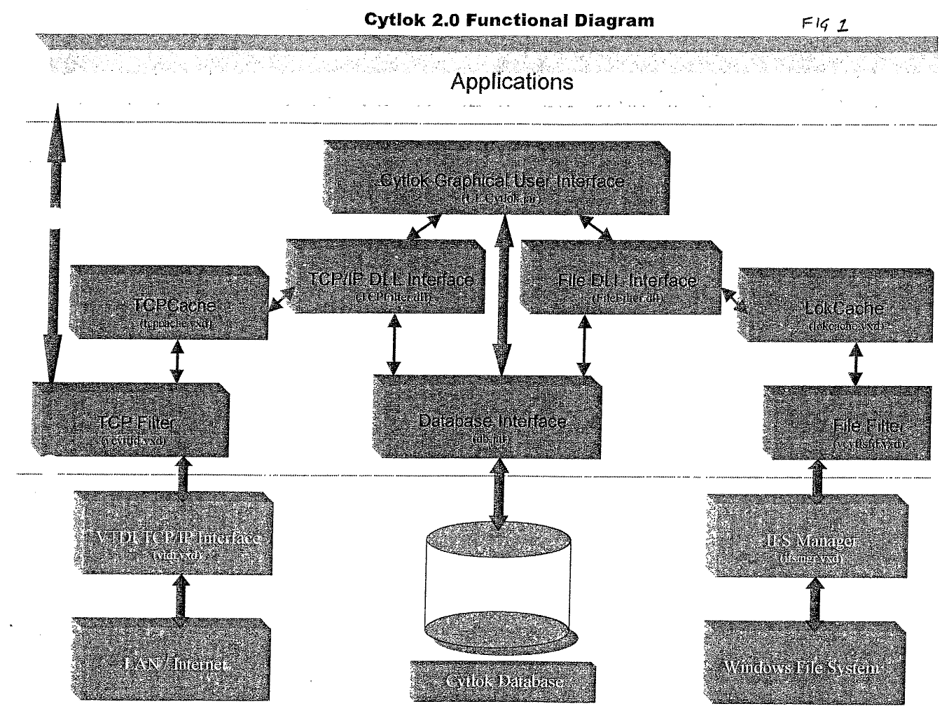

FIG. 1 is a functional block diagram illustrating a system according to one aspect of the present invention. As may be seen, the system includes a pair of caches, a pair of filters, a database and a plurality of interface modules for preventing access to the computer memory.

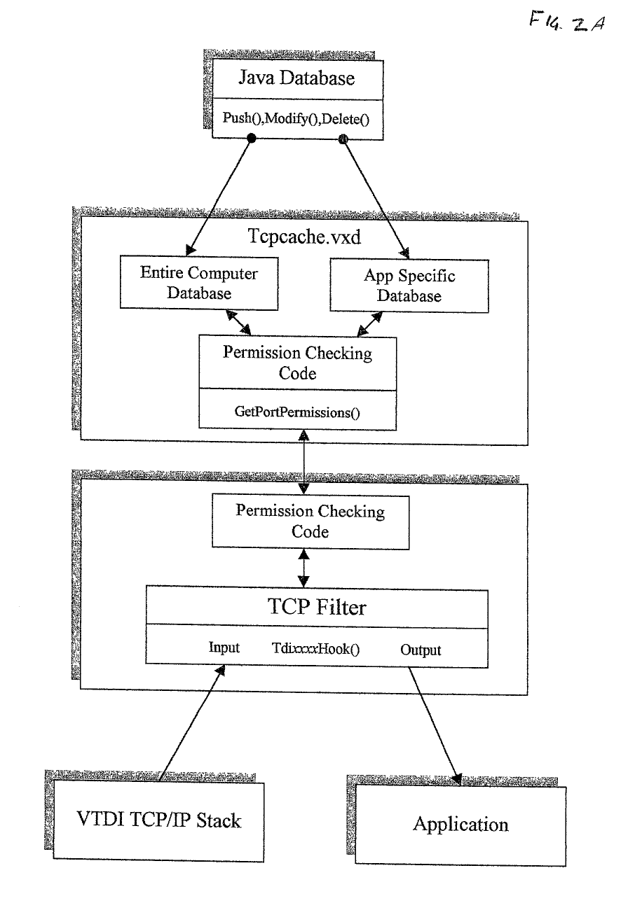

FIGS. 2A and 2B are block diagrams illustrating the functional allocations of the present invention in terms of a process flow. As may be seen, a routine seeking access to the computer memory must be cleared for access by at least two different permission checking algorithms that work in relation to a database to determine whether access should be allowed. FIG. 2A, more specifically, illustrates the operation of the TcpCache while FIG. 2B illustrates the operation of the LokCache.

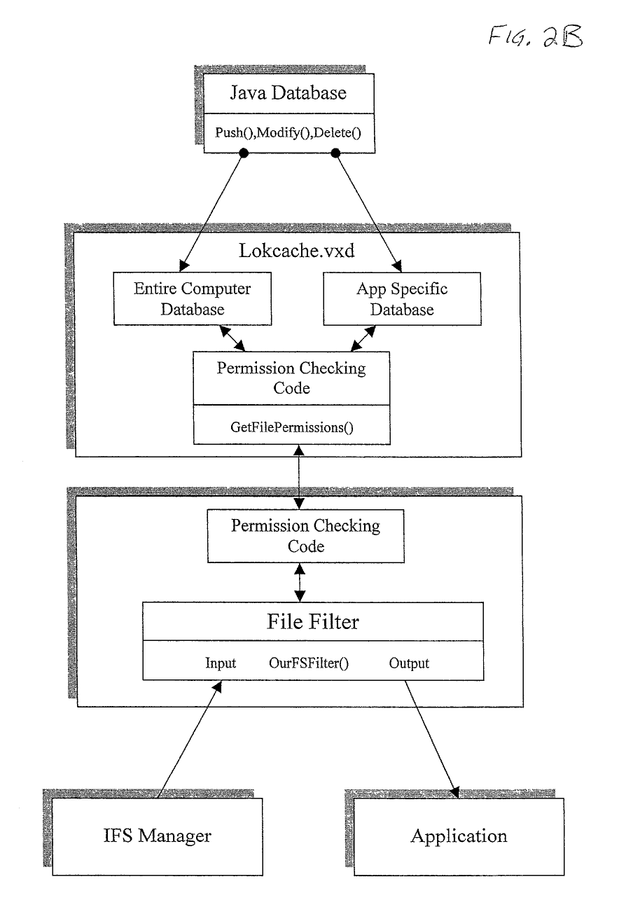

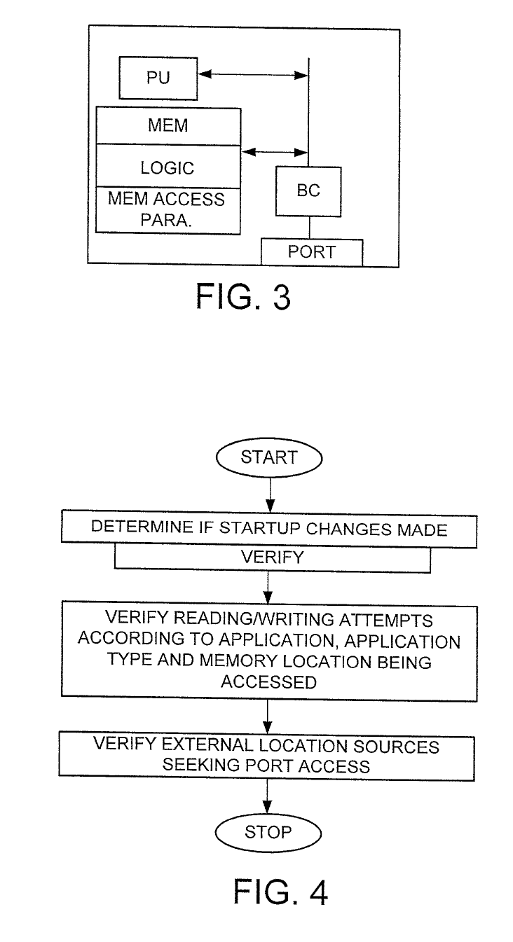

FIG. 3 is a functional block diagram of a computer system formed according to the present invention. Referring now to FIG. 3, a computer includes a processing unit, a memory, an internal bus and a bus controller. The processing unit executes computer instructions stored in the memory to provide protection for the computer memory. The computer memory includes a portion for storing operational logic that defines the algorithms that protect the computer memory and a portion for storing specific parameters that define what routines, applications or systems are allowed to access the computer memory in addition to defining the level of access allowed. Accordingly, as an external system, for example, seeks to read the contents of the computer memory, the processing unit detects the same as a result of the computer instructions it executes that controls such access. For example, the logic defined by the computer instructions within the memory are illustrated, in part, by the method shown in FIG. 4.

FIG. 4 is a flow chart illustrating a process for protecting computer memory according to one embodiment of the present invention. As may be seen from examining FIG. 4, the inventive process includes determining, at power up, whether any changes have been made to the start up file(s) of the computer. Additionally, the process includes verify, if changes were made, that they were authorized changes. Additionally, the process includes verifying that any applications seeking to read or write to memory has authority to do so. Finally, the method includes verifying that any external routine seeking access to any port of the computer is authorized to do so.

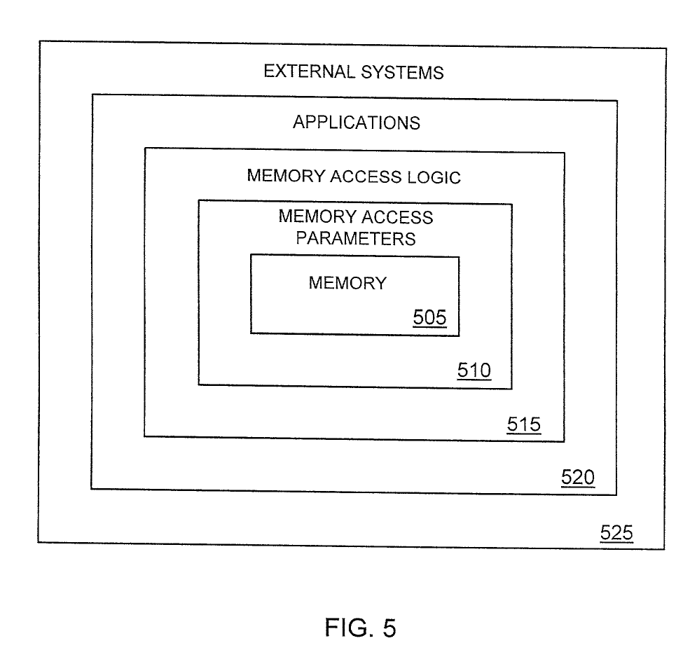

FIG. 5 illustrates the system design in terms of software and operational layers. As may be seen, memory cannot be accessed without approval being issued by a computer unit that is executing the memory access logic and without the conditions complying with the memory access parameters. Thus, any external system or even any internal application within the computer may not access memory without going through and gaining the approval granted by the memory access logic and parameters.

One advantage of the present system is that it will run in any windows-based platform. The system registry, in the described embodiment, will be modified to load and execute a VxD module first. The system will then check system integrity. This is done using a check against a log of the last successful startup. Any changes that are made to the startup sequence are verified to the user through a dialog box. The system will not modify another VxD module initialization. By not changing any existing VxD, and by careful positioning, there are no conflicts with existing software.

A second advantage of the described embodiment is that the system will protect the hard drive from unauthorized reading and writing. The system will take as input, permission definitions from a database or user input. It will also read a database index from the hard drive and load it into memory. This is done at program execution time by using the file.vxd open function. Additionally, the system will cross check against the hard drive permission database for verification. If a violation occurs, it is caught by one of the VxD's and is passed to monitor.exe for user intervention. The system will allow the user to define how to process hard drive security violations. For example, the user can stop the violating application or the user can allow and update the database to allow in the future or he/she can allow for “x” amount of time. The system will notify the user if any hard drive permission violations occur and will log applications that try to violate permission settings. The system will log attribute changes and Cytlok will return Cytlock permission when a file's attribute is requested.

Additionally, the system will protect workstation from unauthorized TCP/IP connections. In this regard, the system will take as input permission definitions from a database or user input, read a database index from the hard drive and load into memory, cross check against the TCP/IP permissions database for verification, prompt the user for input of how to process network connection violations, signal notify the user if any network permission violations occur and log TCP/.IP connections and record the information.

The system will also allow the user to control their resources. It will allow the user to set permissions for hard drive access, as well as, TCP/IP connections. It will empower user to grant read, write, transmit and execute permissions for files and folders in hard drive; grant allow or disallow permissions for TCP/IP connections; and grant allow or disallow permissions for hard drive usage.

Finally, the system will display system protection processing. It will display a splash screen and icon on the tool bar when executing, notify the user when a TCP/IP connection is active, display Internet activity to and from the workstation, notify the user with a dialog box when a security permission is violated, and issue a security violation message and error code when appropriate.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

Additionally, the computer instructions may be modified to create permutations of the inventive methods or signals whose differences from what is disclosed and claimed are insubstantial. As may be seen, the described embodiments may be modified in many different ways without departing from the scope or teachings of the invention.

1. A system for protecting memory, comprising:
memory for storing access logic and parameters; and
circuitry for executing the access logic in relation to the parameters that grant access to memory only to resident applications on the computer that are authorized to gain access to the memory.

2. The system of claim 1 wherein port access is only granted to external sources identified as known good external sources within the memory access parameters.

3. The system of claim 1 wherein the logic creates, upon execution by the processor, a plurality of filters that block access to memory.

4. The system of claim 3 comprising a plurality of caches that operate with the plurality of filters to determine, on a prompt basis, whether a routine, whether internal or external, is to be given access to memory.

5. A method for protecting a computer system from attacks by hackers, comprising:
examining access logic in relation to an application seeking access to a specified system element; and
determining whether to allow access by the application.
